(19) United States
(12) Patent Application Publication
(10) Pub. No.: US 2015/0356636 A1
(43) Pub. Date: Dec. 10, 2015

(54) SYSTEM AND COMPUTER PROGRAM PRODUCT FOR COLLECTIVELY GATHERING RELIABLE FACTS AND VALIDATION THEREOF

(71) Applicant: François DUNN, Montreal (CA)

(72) Inventor: François DUNN, Montreal (CA)

(21) Appl. No.: 14/730,675

(22) Filed: Jun. 4, 2015

Related U.S. Application Data
(60) Provisional application No. 62/008,838, filed on Jun. 6, 2014.

(51) Int. Cl. G06Q 30/02

(52) U.S. Cl. CPC G06Q 30/0278

(57) ABSTRACT

The present disclosure relates to a system and a computer program product for collectively gathering reliable facts. The system receives a statement, at least one evidence related to the statement, and at least one validity indicator for the at least one evidence. The system assesses a reliability value of the at least one evidence using the at least one corresponding validity indicator. The system further determines a confidence indicator for the statement based on the at least one evidence and the corresponding reliability value. The computer program product comprises instructions which when executed by a processor of a computing device display a statement and an evidence received from the server on a display of the computing device. The instructions when executed also collect one of a validity indicator of the displayed evidence or a new evidence related to the displayed statement, which are transmitted to the server.

### TECHNICAL FIELD

The present disclosure relates to the field of collaborative information gathering and validation thereof. More specifically, the present disclosure relates to a system and computer program product for collectively gathering reliable facts.

### BACKGROUND

Collaborative information gathering via the Internet allows a multitude of users to share their knowledge on a multitude of topics, via a centralized on-line collaborative tool. For instance, Wikipedia is a collaborative on-line encyclopedia, which consists of a website having a plurality of sections, each section addressing a specific topic. Each section can be updated by users who may add, remove or modify information related to the section.

One critical issue with such on-line collaborative tools is the accuracy of the information provided by participating users. Fact checking may be self-organized, relying on the collaboration between participating users to converge to an accurate information for each topic addressed via the on-line collaborative tool. Alternatively or complementarily, a team of moderators may perform fact checking. However, with on-line collaborative tools such as Wikipedia, the amount of information to be verified makes it almost impossible to rely exclusively on a team of moderators.

One way to facilitate fact checking is to provide references (e.g. in the form of hyperlinks to sections of web sites) in support of the information provided by a contributor. However, the provision of references is often on a voluntary basis, and is not systematically integrated in the fact checking process implemented by the on-line collaborative tool.

Another way to facilitate fact checking is to provide the ability for visitors of the on-line collaborative tool to vote on a relevance of the information provided by a contributor. Some on-line collaborative tools have implemented such a voting process, but the voting process is generally limited to the validation of the information provided by contributors. Visitors do not have the capability to vote on additional aspects, such as the relevance of the topics addressed.

Thus, existing on-line collaborative tools each have strengths and weaknesses in terms of validation of the information provided by contributors, and in terms of the level of collaboration offered to contributors and visitors. Therefore, there is a need for a new system and computer program product for implementing an on-line collaborative tool capable of collectively gathering reliable facts.

### SUMMARY

According to a first aspect, the present disclosure provides a system for collectively gathering reliable facts. The system comprises a memory. The system also comprises a communication interface for receiving a statement, receiving an evidence related to the statement, and receiving at least one validity indicator for the evidence. The system further comprises a processing unit. The processing unit creates a factual record for the statement and stores the factual record in the memory. The factual record comprises the statement, the evidence and the at least one validity indicator for the evidence. The processing unit assesses a reliability value of the evidence using the at least one corresponding validity indicator. The processing unit determines a confidence indicator for the statement based on the evidence and the corresponding reliability value. The processing unit updates the factual record with the reliability value of the evidence and the confidence indicator of the statement.

According to another aspect, the present disclosure provides a computer program product deliverable via an electronically-readable media such as storage media and communication links. The computer program product comprises instructions which when executed by a processor of a computing device provide for collectively validating facts. Executing the instructions comprises receiving from a server a factual record. The factual record includes a statement and an evidence related to the statement. Executing the instructions comprises displaying the statement and the evidence on a display of the computing device. Executing the instructions comprises receiving via a user interface of the computing device one of the following: a validity indicator for the evidence or a new evidence related to the statement. Executing the instructions comprises transmitting to the server one of the following: the validity indicator for the evidence or the new evidence related to the statement.

### BRIEF DESCRIPTION OF THE DRAWINGS

Embodiments of the disclosure will be described by way of example only with reference to the accompanying drawings, in which:

FIG. 1 illustrates a schematic representation of relationships between elements of a factual record;

FIG. 2 illustrates a computing device for collectively validating facts;

FIGS. 3A-E illustrate a Graphical User Interface (GUI) of the computing device of FIG. 2.

FIGS. 4A and 4B illustrate steps of a method for collectively gathering reliable facts; and

FIG. 5 illustrates a server for collectively gathering reliable facts.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to collective gathering of reliable facts.

### DEFINITIONS

Fact: a thing that is indisputably the case, verifiable from experience of observation, also used to refer to an objective piece of information used as evidence or as part of a report or news article;

Statement: definite or clear expression of something in speech or writing that could be an assertion or an account of facts, views or plans;

Evidence: available body of information indicating whether a statement is true and/or valid;

Gathering: bring together and take in from scattered places or sources.

Validity: the quality of being logically or factually sound, and/or the state of being rationally, plausibly, legally or officially binding or acceptable;

Reliability: the quality of being based on information which can be trusted or verified;

Assessing: evaluate or estimate the nature, worth, ability or quality;

Confidence: state of feeling certain about the truth of something, also used to refer to the feeling or belief that one can rely on something;

Determining: ascertain or establish exactly, typically as a result of research or calculation;

Factual record: a set of information (e.g. statement, evidence, validity indicator, reliability value, confidence indicator, etc.) related to the collective gathering and validation of facts. The information of the factual record evolves along the process of gathering and validating facts.

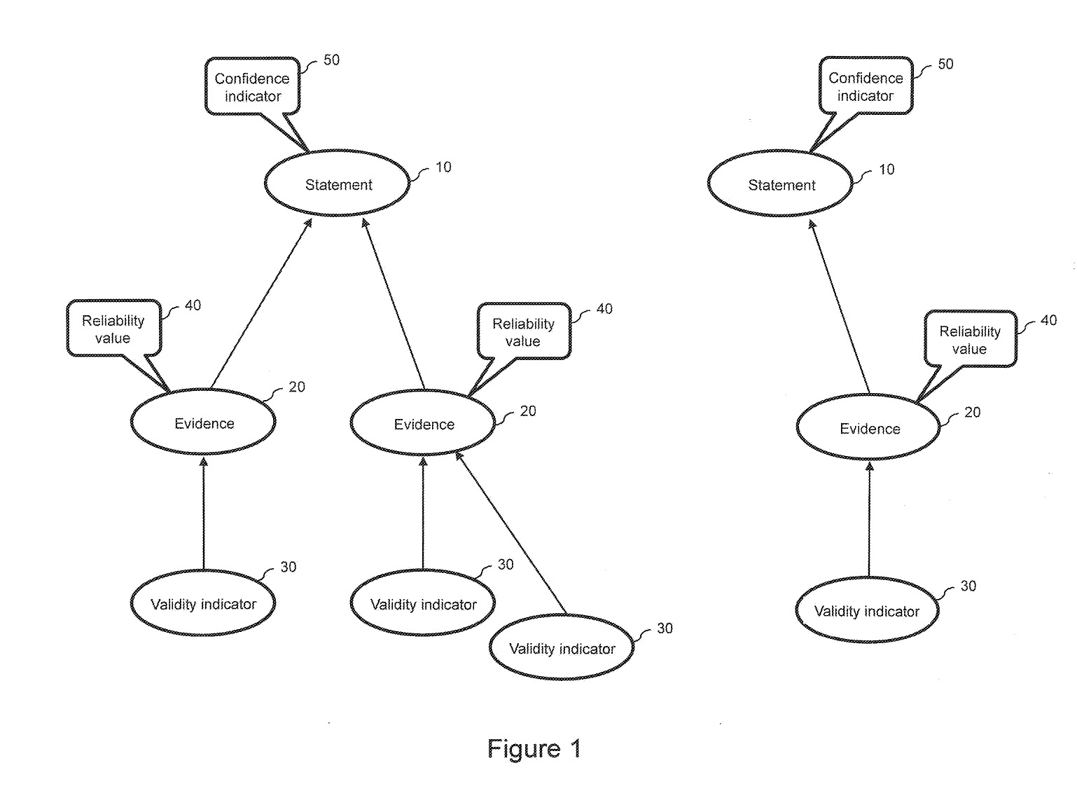

Referring now to FIG. 1, a schematic representation of relationships between elements of a factual record in a system for collectively gathering reliable facts is represented.

FIG. 1 illustrates that one or more statements 10 can be evaluated by the system. For each specific statement 10, one or more evidences 20 related to the specific statement 10 can be provided by a community of contributors. For each specific evidence 20, one or more validity indicators 30 can be provided. Several types of validity indicators 30 may be available. For instance, a first type of validity indicator 30 may consist of a plurality of votes provided by the community of contributors. A second type of validity indicator 30 may be provided by a pre-defined person (or group of persons), such as a moderator or a skilled person in the field related to the statement 10. For each specific evidence 20, a corresponding reliability value 40 can be assessed based on the validity indicator(s) associated to the specific evidence 20. For each specific statement 10, a corresponding confidence indicator 50 can be determined, based on the evidence(s) 20 associated to the specific statement 10 and on the corresponding reliability value(s) 40.

A factual record (not represented in FIG. 1) includes data related to a particular statement 10. As will be detailed later in the description, the data included in a particular factual record evolve over time, and may include the particular statement 10, a confidence indicator 50 of the particular statement 10, one or more evidence(s) 20 related to the particular statement 10, one or more reliability value(s) 40 associated to the evidence(s) 20, and one or more validity indicator(s) 30 per evidence 20.

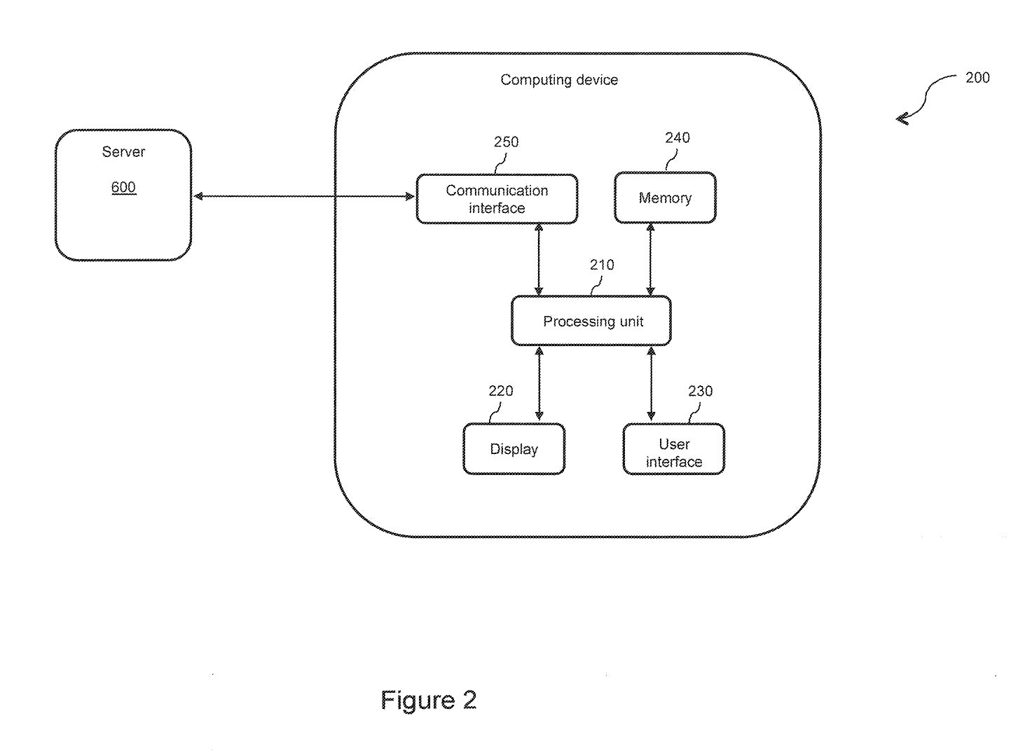

Referring now concurrently to FIGS. 2, 3A-3F and 4A-4B, a computing device 200 for collectively gathering reliable facts, a graphical user interface (GUI) 300 for collectively gathering reliable facts, and a method 400 for collectively gathering reliable facts are illustrated.

The computing device 200 is used by a member of the community of contributors, to participate in the collective gathering of reliable facts. The computing device 200 may consist of various types of devices, including a computer, a laptop, a smartphone, a tablet, a connected television, etc.

The computing device 200 comprises a processing unit 210, having one or more processors (not represented in FIG. 2) capable of executing instructions of a computer program. The computing device 200 comprises a memory 240 for storing instructions of the computer program, data generated by the execution of the computer program, etc. Only a single memory 240 is represented in FIG. 2, but the computing device 200 may comprise several memories, including volatile memory (such as a volatile Random Access Memory (RAM)) and non-volatile memory (such as a hard drive). The computing device 200 comprises a display 220 (e.g. a regular screen or a tactile screen) for displaying data generated by the computer program and a user interface 230 (e.g. a keyboard, a mouse, a tactile screen) for allowing a user to interact with the computer program. The computing device 200 further comprises a communication interface 250 for exchanging data with other entities (such as a server 600) via communication links (e.g. a cellular network, a fixed Internet network, etc.).

In the rest of the description, we refer to specific instructions of a specific computer program. The instructions are comprised in a computer program product and provide for collectively validating facts when executed by a processor of the processing unit 210. The computer program product is deliverable via an electronically-readable media such as a storage media or communication links (via the communication interface 250). The instructions of the computer program implement the steps of the method 400 which are executed on the computing device 200.

The server 600 is a centralized entity which exchanges data with a plurality of computing devices 200, and more specifically computes data collected by the plurality of computing devices 200 in order to implement the process of collectively gathering reliable facts. The server 600 will be detailed later in the description.

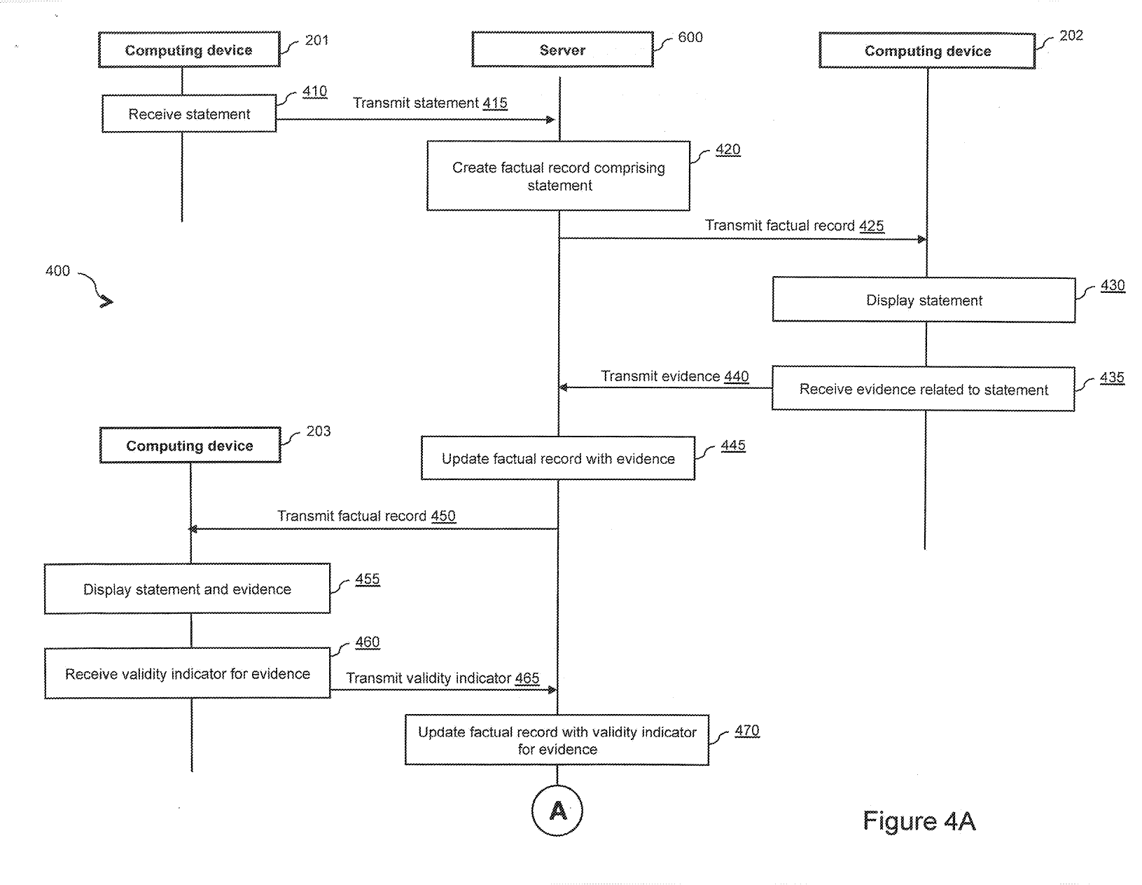

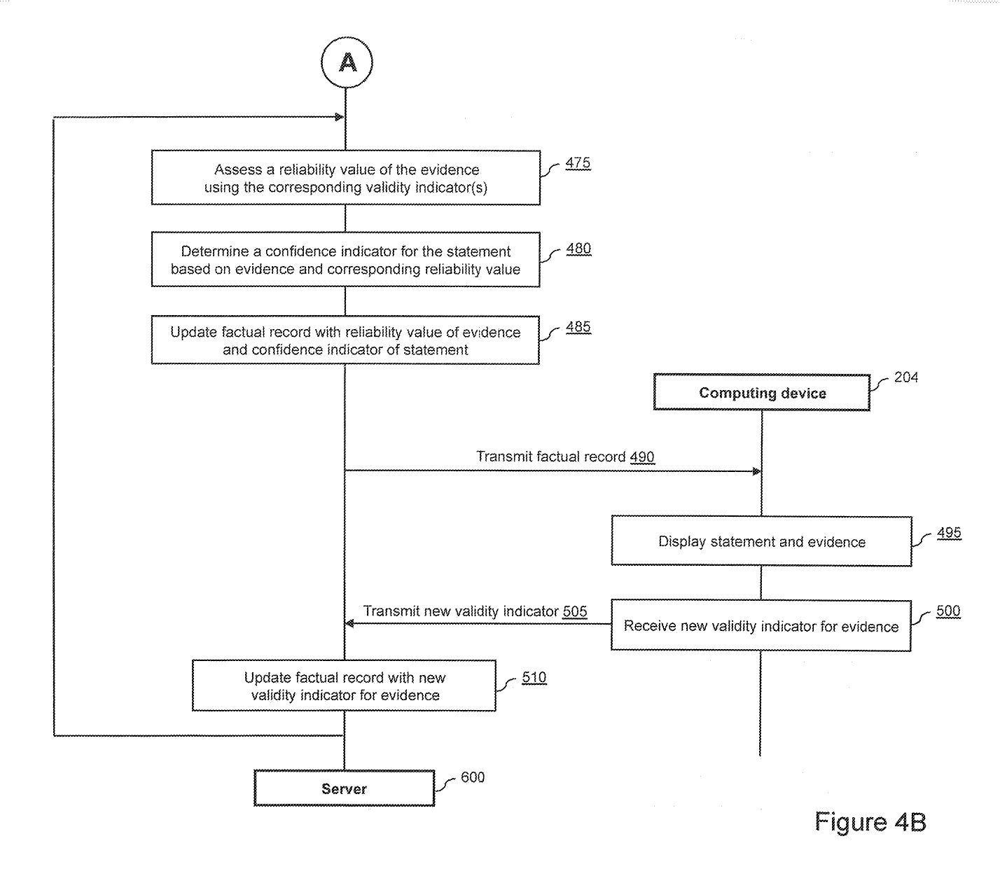

FIGS. 4A and 4B are an exemplary illustration of interactions of the server 600 with four different computing devices 201, 202, 203 and 204 corresponding to the computing device 200. Each of the four computing devices 201, 202, 203 and 204 execute instructions of the computer program product, to implement different stages of the collective validation of facts by computing devices 200. FIGS. 4A and 4B more specifically illustrate the processing of a specific statement, and are not meant to be limitative, since more or less computing devices 200 may be involved in the processing of this specific statement. In particular, the same processing device 200 may perform steps performed by two or more processing devices (e.g. 201 and 203) in FIGS. 4A and 4B.

Executing the instructions of the computer program product includes displaying the GUI 300 on the display 220 of a computing device 200. The GUI 300 facilitates interactions with the user of the computing device 220, by displaying data generated by the processing unit 210 when executing the instructions of the computer program or displaying data received via the communication interface 250. The GUI 300 also facilitates the provision of data by the user via the user interface 230, by displaying interactive graphical elements (such as menus, data collection widgets, etc.) for provisioning the data.

The computer program may consist of an application executed by the computing device 220 to implement the method 400 (e.g. an applet on a tablet or a smartphone), and the GUI 300 consists in a dedicated interface of the computer program. Alternatively, the computer program may consist of a standard web browser (using dedicated web pages, scripts, etc. to implement the method 400), and the GUI 300 consists of a standard web interface customized by the dedicated web pages, scripts, etc.

In a particular aspect, executing the instructions of the computer program product comprises receiving 410 via the user interface 230 of a first computing device 201 a new statement (not represented in the Figures). Executing the instructions further comprises transmitting 415 the new statement to the server 600 via the communication interface 250 of the first computing device 201. Although not represented in the Figures, the GUI 300 may comprise a dedicated page including a graphical element (such as a text entry, etc.) for allowing the user to enter the new statement via the user interface 230.

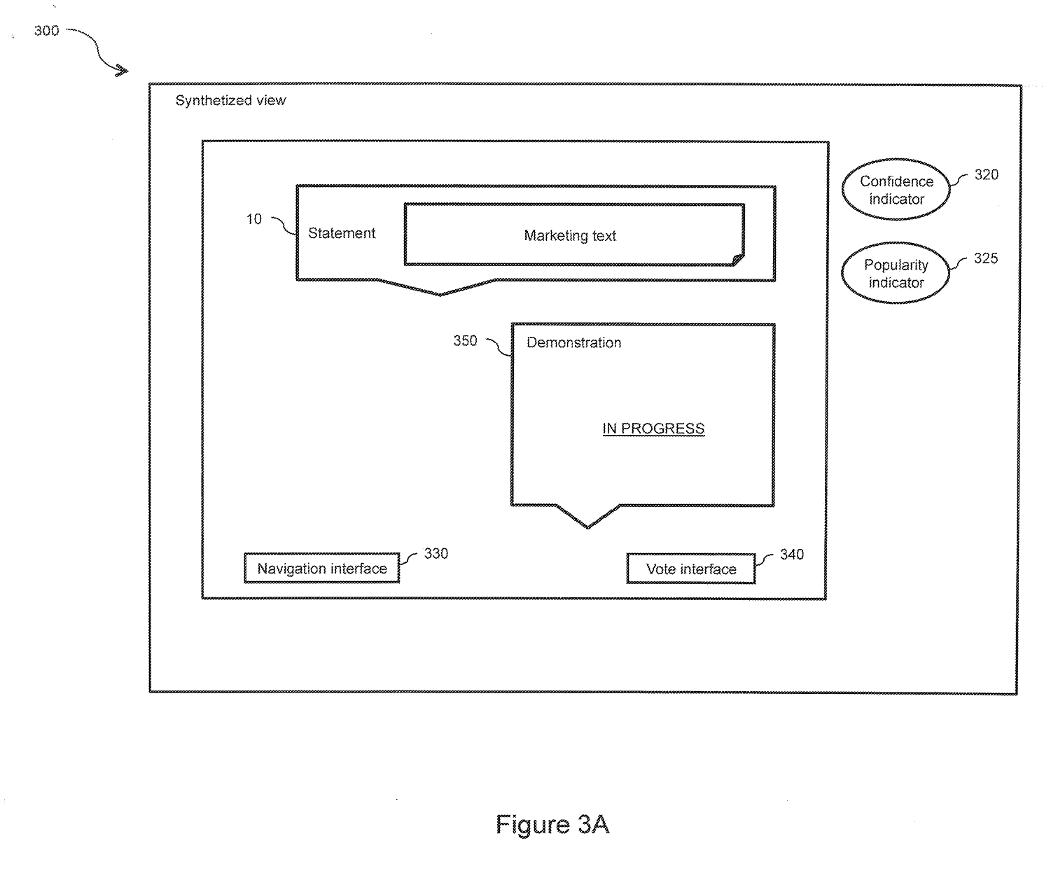

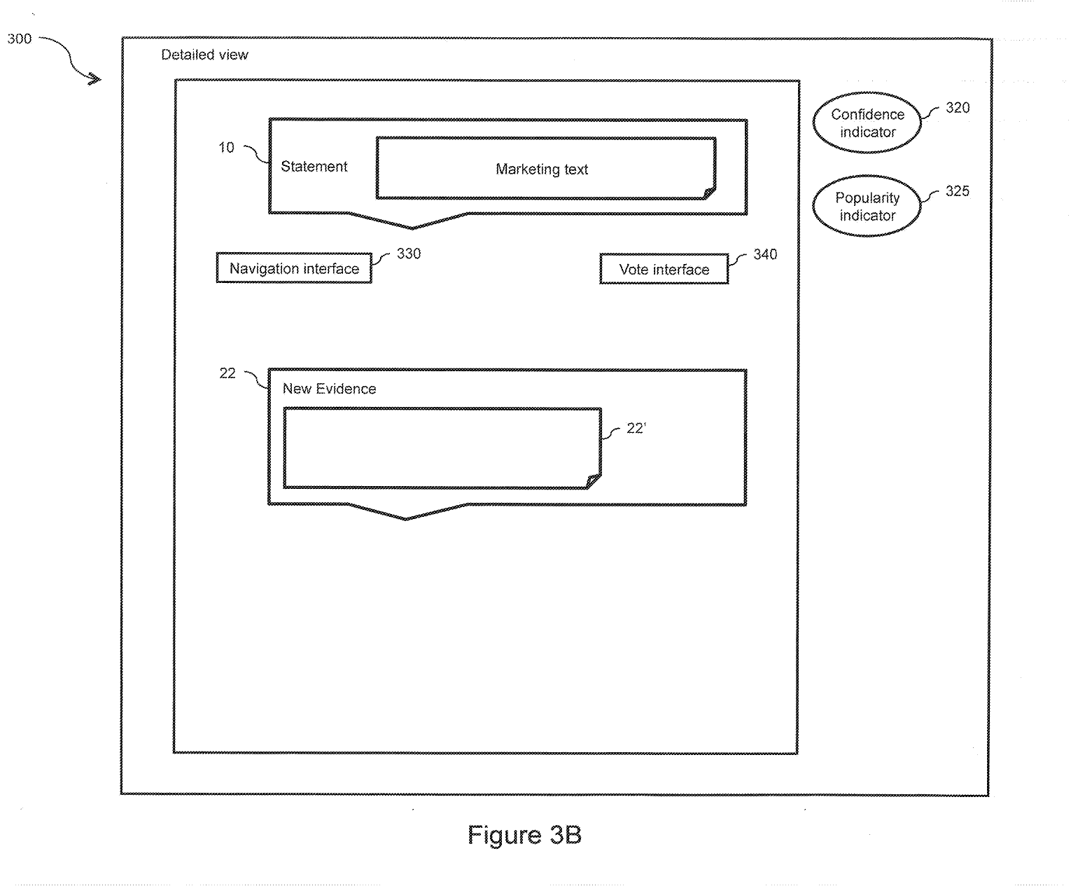

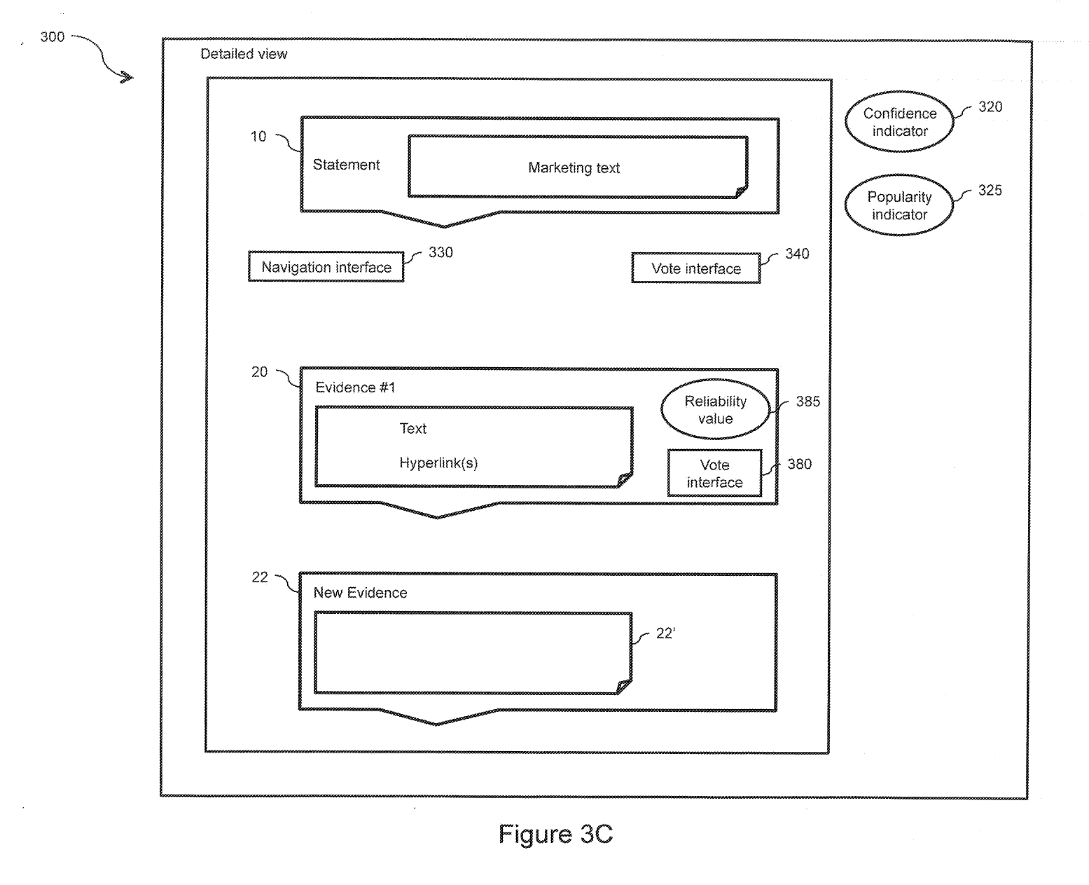

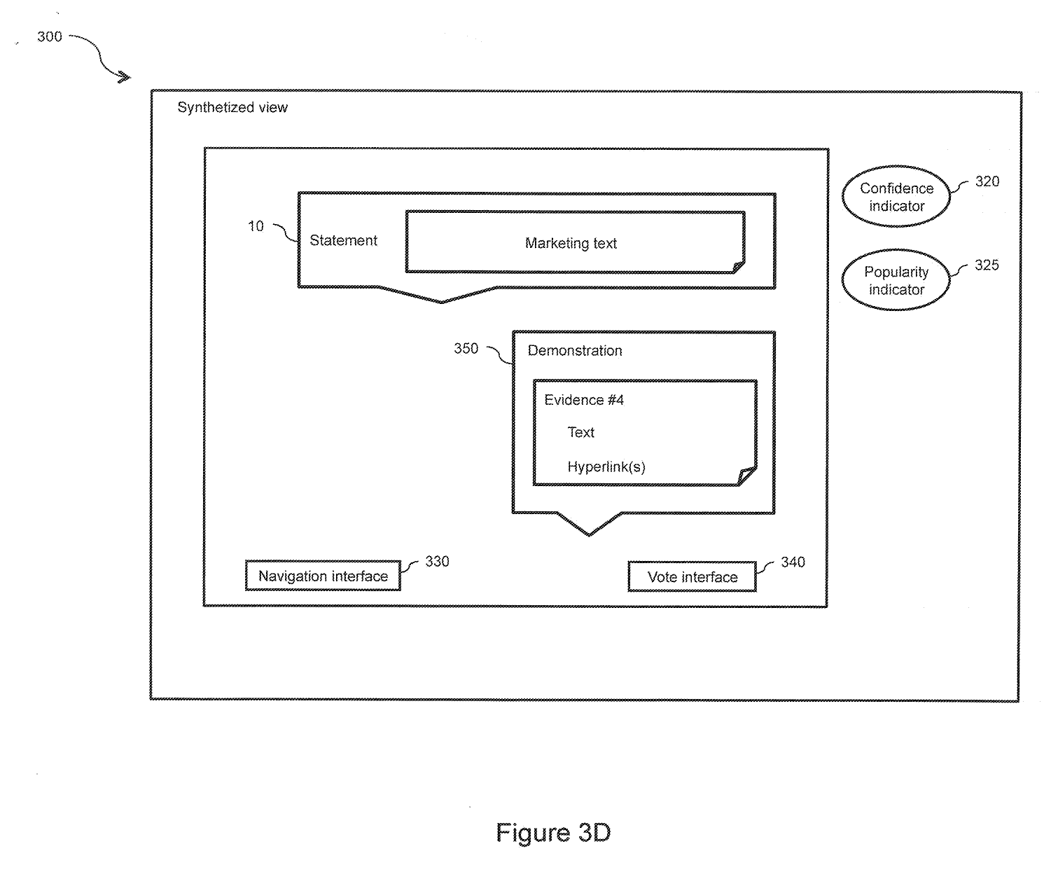

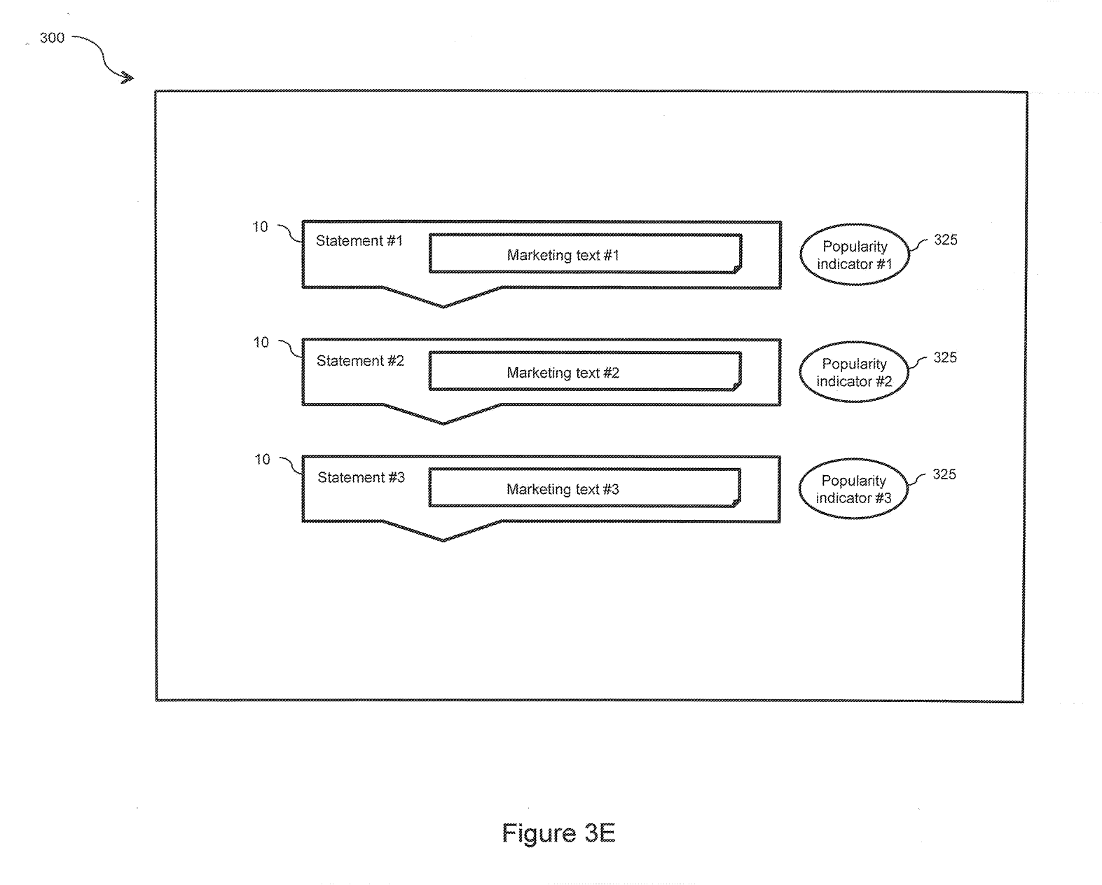

In another particular aspect, executing the instructions of the computer program product comprises receiving 425 from the server 600 via the communication interface 250 of a second computing device 202 a factual record. This factual record is a factual record at a preliminary stage, generated by the server 600 (as will be detailed later in the description), and comprising a statement 10 and no evidence yet. Executing the instructions further comprises displaying 430 the statement 10 on the display 220 of the computing device 200, and more specifically in the GUI 300, as illustrated in FIGS. 3A and 3B.

FIGS. 3A and 3D illustrate a first page of the GUI 300 for presenting a synthetized view of the data related to a factual record. The synthetized view displays the statement 10 of the factual record. The synthetized view may be the default view presented to a user of a computing device 200

FIGS. 3B and 3C illustrate a second page of the GUI 300 for presenting a detailed view of the data related to a factual record. The detailed view displays the statement 10 of the factual record, a graphical element for the user to enter a new evidence 22, and evidence(s) 20 related to the statement 10 if present in the factual record.

A navigation interface 330 (e.g. an icon, a button, etc.) allows the user to navigate between the synthetized view (FIGS. 3A and 3D) and the detailed view (FIGS. 3B and 3C).

Executing the instructions further comprises receiving 435 via the user interface 230 of the second computing device 202 a new evidence 22 related to the statement 10, and transmitting the new evidence 22 to the server 600. FIG. 3B illustrates the currently described case, where the factual record comprises a statement 10 and no evidence yet. A first new evidence 22 is entered by the user via the detailed view of the GUI 300, through a graphical element 22′ (such as a text entry, etc.).

In still another particular aspect, executing the instructions of the computer program product comprises receiving 450 from the server 600 via the communication interface 250 of a third computing device 203 a factual record. The factual record includes a statement 10 and an evidence 20 related to the statement 10.

Executing the instructions further comprises displaying 455 the statement 10 and the evidence 20 on the display 220 of the computing device 203. For instance, the statement 10 is displayed in the synthetized view of the GUI 300 illustrated in FIG. 3A. Additionally, the statement 10 and the evidence 20 are both displayed in the detailed view of the GUI 300 illustrated in FIG. 3C.

Executing the instructions further comprises receiving via the user interface 230 of the computing device 203 one of the following: a validity indicator for the evidence 20 or a new evidence 22 related to the statement 10; and transmitting to the server 600 one of the following: the validity indicator for the evidence 20 or the new evidence 22 related to the statement 10.

FIG. 4A illustrates the reception 460 of the validity indicator for the evidence 20 by the computing device 203, and the transmission 465 of the validity indicator to the server 600. FIG. 3C illustrates that the validity indicator may be received via a vote interface 380 associated to the evidence 20. The vote interface 380 may consist of a graphical element, such as a menu, button(s), icon(s), etc. The validity indicator may consist of a determination by the user that the evidence 20 is either relevant or irrelevant, via the vote interface 380.

FIG. 4A does not specifically illustrate the reception of the new evidence 22 related to the statement 10 by the computing device 203, and the transmission of the new evidence to the server 600. However, these steps are similar to the steps 435 and 440 performed by the computing device 202, and have been described already. FIG. 3C illustrates the display in the detailed view of the GUI 300 of the received evidence 20 and of a graphical element 22′ (such as a text entry, etc.) for entering the new evidence 22.

FIGS. 4A and 4B illustrate that a first validity indicator for the evidence 20 is received 460 at the computing device 203, and transmitted to the server 600. The factual record is later transmitted 490 to a fourth computing device 204, the statement 10 and the evidence 20 of the factual record are displayed 495 on the display 220 of the computing device 204, a new validity indicator for the evidence 20 is received 500 via the user interface 230 of the computing device 204, and the new validity indicator is transmitted 505 to the server 600. More generally, for a particular evidence 20 related to a particular statement 10 of a factual record, a plurality of validity indicators can be generated (via the vote interface 380 represented in FIG. 3C) by a plurality of computing devices 200 and transmitted to the server 600.

For simplification purposes, FIG. 3C illustrates the display in the detailed view of the GUI 300 of a single received evidence 20. However, the factual record received 450 by the computing device 203 may include a plurality of evidences 20 related to the statement 10. In this case, the plurality of evidences 20 is displayed on the display 220 of the computing device 203. A specific validity indicator can be received 460 via the user interface 230 of the computing device 203 for a specific one among the plurality of evidences 20, and the specific validity indicator is transmitted 465 to the server 600. The data transmitted to the server 600 may also include an identification of the specific evidence 20 to which the specific validity indicator is related. The detailed view of the GUI 300 may display the plurality of evidences 20 in a convenient manner, as is well known in the art. For example, the plurality of evidences 20 may be stacked vertically and a particular navigation interface (such as a scroller) may be used if all the evidences cannot be displayed on the detailed view of the GUI 300 at the same time. Each one of the plurality of evidences 20 may have its own vote interface 380, in order to allow the user of the computing device 203 to generate a specific validity indicator for each specific evidence 20 displayed in the GUI 300.

In yet another particular aspect, the statement 10 may consist of a marketing text related to one of a product or a service. For example, the statement 10 may assert that a product has a particular quality, is particularly useful in particular circumstances, etc. Similarly, the statement 10 may assert that a service is very popular among a particular category of users, is well adapted for addressing a particular need or problem, etc. The marketing text may have a pre-defined maximum number of characters.

In another particular aspect, the evidence 20 comprises a text and at least one hyperlink related to the text. The text may include fact(s) gathered by a user of a computing device 220 in order to prove the validity of the corresponding statement 10. The one or more hyperlinks support the gathered fact(s), by referencing web pages of web sites where additional information can be found in support of the fact(s). Each evidence 20 may include a pre-defined maximum number of hyperlinks, for instance three. Additionally, the text may have a pre-defined maximum number of characters.

In still another particular aspect, the factual records transmitted by the server 600 to the computing devices 200 may include at least one of the following: a confidence indicator of the statement 10 and a reliability value of the evidence 20. The confidence indicator of the statement 10 is determined by the server 600 and the reliability value of the evidence 20 is assessed by the server 600, as will be detailed later in the description. The at least one of the confidence indicator of the statement 10 and the reliability value of the evidence 20 is displayed on the display 220 of the computing device 200.

FIGS. 3A and 3D illustrate that a received confidence indicator 320 related to a received statement 10 can be displayed in the synthetized view of the GUI 300; while FIGS. 3B and 3C illustrate that the received confidence indicator 320 can be displayed in the synthetized view of the GUI 300. FIG. 3C illustrates that a received reliability value 385 related to a received evidence 20 can be displayed in the detailed view of the GUI 300. In the case where several received evidences 20 associated to the statement 10 are displayed in the detailed view of the GUI 300 (not illustrated in FIG. 3C for simplification purposes), each specific evidence 20 has its own specific reliability value 385 assessed and transmitted by the server 600, which is displayed with its corresponding specific evidence 20.

In yet another particular aspect, executing the instructions of the computer program product comprises receiving via the user interface 230 of a computing device 200 a validity indicator for the statement 10. Executing the instructions further comprises transmitting the validity indicator for the statement 10 to the server 600 via the communication interface 250 of the computing device 200. The validity indicator for the statement 10 can be used by the server 600 for determining the confidence indicator of the statement 10, as will be detailed later in the description. FIGS. 3A-D illustrate that the validity indicator for the statement 10 may be received via a vote interface 340 associated to the statement 10. The vote interface 340 may consist of a graphical element, such as a menu, button(s), icon(s), etc. The validity indicator of the statement 10 may consist of a determination by a user of the computing device 200 that the statement 10 is either relevant or irrelevant, via the vote interface 340. With this additional option, the user may directly vote on the statement 10, submit its own evidence 22 or vote on evidence(s) 20 submitted by other users (as illustrated in FIG. 3C).

In another particular aspect, the factual records transmitted by the server 600 to the computing devices 200 may include a demonstration of the statement 10. As will be detailed later in the description, the server 600 may determine at some point that the statement 10 is true, based for example on the corresponding confidence indicator. The server 600 then generates a demonstration for the statement 10. For example, the demonstration may consist of the evidence 20 related to the statement 10 with the highest reliability value. The demonstration 350 of the statement 10 transmitted by the server 600 may be displayed in the synthetized view of the GUI 300 (represented in FIGS. 3A and 3D). For illustration purposes, FIG. 3A represents a case where the demonstration 350 has not been determined yet by the server 600, and is consequently not transmitted to the computing device 200. Thus, the synthetized view of the GUI 300 may include an indicator (for example, the text IN PROGRESS as illustrated in FIG. 3A) that no demonstration 350 has been determined yet. FIG. 3D represents a case where the demonstration 350 has been determined by the server 600, and is transmitted to the computing device 200. Thus, the synthetized view of the GUI 300 may include the demonstration 350 of the statement 10 (for example, evidence #4 which has been determined to have the highest reliability value by the server 600, as illustrated in FIG. 3D).

In still another particular aspect, the factual records transmitted by the server 600 to the computing devices 200 may include a popularity indicator of the statement 10. The server 600 may determine the popularity indicator of the statement 10 based on one or more criteria, including the number of times the statement 10 is transmitted to a computing device 200, the confidence indicator of the statement 10, the number of evidences 20 related to the statement 10, the number of validity indicators related to the evidences 20 of the statement 10, etc. The popularity indicator 325 of the statement 10 transmitted by the server 600 may be displayed in the synthetized and/or detailed views of the GUI 300 (as illustrated in FIGS. 3A-D).

In yet another particular aspect, executing the instructions of the computer program product may comprise determining by a user of the computing device 200 one or several criteria related to statements 10. The GUI 300 may include a specific page (not represented in the Figures) with dedicated graphical element(s) (e.g. a menu, a text entry, etc.) for allowing the user to select the criteria via the user interface 230 of the device 200. The criteria may include categories to which the statements 10 belong, key-words included in the text of the statements, date of creation of the statements 10, etc. The criteria are transmitted to the server 600, which returns a set of factual records for which the statements 10 match the criteria. The GUI 300 may include a specific page illustrated in FIG. 3E for displaying the received statements 10 corresponding to the criteria. The user may select (via the user interface 230) one among the plurality of displayed statements 10, based on his interest for the text of the selected statement 10. Additionally, the popularity indicator 325 of each statement 10 may be displayed, to help the user in its choice. Although not illustrated in FIG. 3E, the confidence indicator 320 of each statement 10 may also be displayed, to help the user in its choice. Upon selection of a specific statement 10 by the user, the synthetized view (illustrated in FIGS. 3A and 3D) corresponding to the selected statement 10 may be displayed in the GUI 300. From there, the user may navigated between synthetized view (FIGS. 3A and 3D) and the detailed view (FIGS. 3B and 3C) via the navigation interface 330.

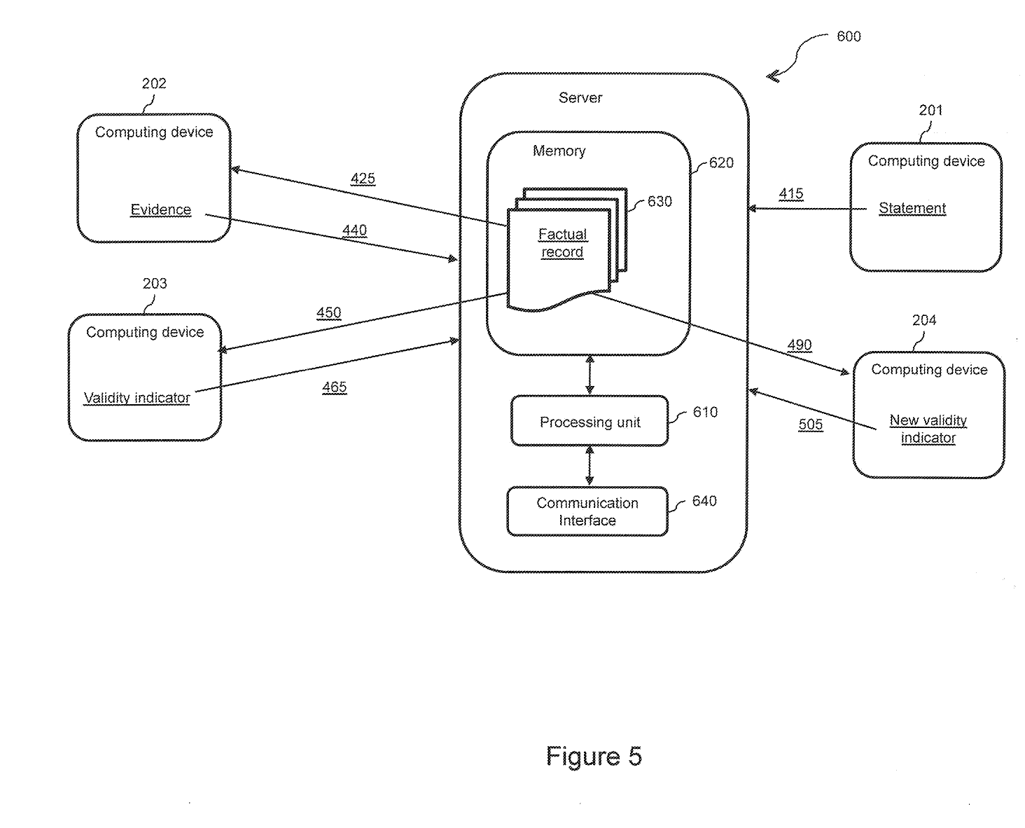

Reference is now made concurrently to FIGS. 4A-4B, and to FIG. 5 which represents the server 600 for collectively gathering reliable facts.

The server 600 comprises a processing unit 610, having one or more processors (not represented in FIG. 5) capable of executing instructions of a computer program. The server 600 comprises a memory 620 for storing instructions of the computer program, data generated by the execution of the computer program such as factual records 630, etc. Only a single memory 620 is represented in FIG. 5, but the server 600 may comprise several memories, including volatile memory (such as a volatile Random Access Memory (RAM)) and non-volatile memory (such as a hard drive). The server 600 further comprises a communication interface 640 for exchanging data with other entities (such as the computing devices 201, 202, 203 and 204) via communication links (e.g. a cellular network, a fixed Internet network, etc.).

The server 600 receives 415 via its communication interface 640 a statement sent by a computing device (e.g. 201). The processing unit 610 of the server 600 creates 420 a factual record 630 comprising the received statement and stores the factual record 630 in its memory 620.

The server 600 may transmit 425 via its communication interface 640 the factual record 630 comprising the statement to one or more computing devices (e.g. 202). The server 600 receives 440 via its communication interface 640 an evidence related to the statement sent by a computing device (e.g. 202). The processing unit 610 of the server 600 updates 445 the factual record 630 with the evidence related to the statement.

The server 600 may transmit (e.g. 450 and 490) via its communication interface 640 the factual record 630 comprising the statement and the evidence to one or more computing devices (e.g. 203 and 204). The server 600 receives via its communication interface 640 at least one validity indicator for the evidence. For example, the server 600 receives 465 via its communication interface 640 a first validity indicator related to the evidence, sent by a computing device (e.g. 203). The server 600 also receives 505 via its communication interface 640 a second validity indicator related to the evidence, sent by another computing device (e.g. 204). The processing unit 610 of the server 600 updates (e.g. 470 and 510) the factual record 630 with the at least one received validity indicator (e.g. first validity indicator received 465 from computing device 203 and second validity indicator received 505 from computing device 204). The server 600 may receive a plurality of validity indicators from a plurality of computing devices (e.g. 201, 202, 203 and 204), and updates the factual record 630 with the plurality of received validity indicators.

The processing unit 610 of the server 600 assesses 475 a reliability value of the evidence using the at least one corresponding validity indicator. The processing unit 610 of the server 600 determines 480 a confidence indicator for the statement based on the evidence and the corresponding reliability value. The processing unit 610 of the server 600 updates 485 the factual record 630 with the assessed reliability value of the evidence and the determined confidence indicator of the statement. As illustrated in FIG. 4B, the steps of assertion 475, determination 480 and update 485 represent an iterative process, which is repeated each time a new validity indicator for the evidence is received by the server 600.

As previously mentioned, the statement may consist of a marketing text related to one of a product or a service. Furthermore, the evidence may comprise a text and at least one hyperlink related to the text.

As previously mentioned, several types of validity indicators may be available. A first type of validity indicator consists in the votes (e.g. the evidence is relevant or irrelevant) of the users of the computing devices (e.g. 203 and 204), and has already been described in details. A second type of validity indicator may consist of a vote (e.g. the evidence is relevant or irrelevant) provided by a pre-defined person, or a predefined group of persons, such as moderator(s) or skilled person(s) in the field related to the statement. A moderator or a skilled person may use the GUI 300 represented in FIGS. 3A to 3D in a manner similar to a regular contributing user. However, a moderator or a skilled person shall be identified as such, in order to be granted access to sections (not represented in the Figures) of the GUI 300 reserved for privileged users. At least, a vote from a moderator or a skilled user shall be identified in a particular manner when it is transmitted to the server 600, to differentiate it from a vote transmitted by a regular contributing user. A third type of validity indicator may consist of a source of the evidence. For example, when the evidence comprises hyperlinks, hyperlinks corresponding to a pre-defined set of web sites may be attributed a specific validity coefficient, which depends on each particular web site. Since all existing web sites cannot be taken into consideration, a hyperlink corresponding to a web site which is not in the pre-defined set of web sites may be allocated a default (low) validity coefficient.

The assessment of the reliability value of the evidence may be performed via a dedicated algorithm executed by a processor of the processing unit 610. For example, each particular type of validity indicator may be allocated a particular weighting factor, and the reliability value may be the sum of all received validity indicators weighted by their respective particular weighting factors. Furthermore, the reliability value may be normalized to represent a percentage. Other examples of dedicated algorithms may also be used, as a person skilled in the art would recognize.

In a particular aspect, the communication interface 640 of the server 600 receives a plurality of evidences related to the statement. The plurality of evidences is received from a plurality of computing devices (e.g. 202, 203 and 204). The computing device 201 which transmitted the statement may also transmit an evidence related to the statement. Furthermore, the same computing device (e.g. 202) may transmit several different evidences related to the statement. The processing unit 610 of the server 600 assesses a specific reliability value for each specific evidence among the plurality of received evidences and determines the confidence indicator for the statement based on the plurality of evidences and the corresponding plurality of reliability values.

The determination of the confidence indicator for the statement may be performed via a dedicated algorithm executed by a processor of the processing unit 610. For example, the confidence indicator may be determined by selecting a pre-defined number (e.g. 3) of evidences having the highest reliability value, and calculating the average reliability value of the selected evidences. In a variant of the previous algorithm, a requirement on the selected sources may be that they have a pre-defined number (e.g. 2) of sources (e.g. hyperlinks) with a high validity coefficient (as described previously). Furthermore, the confidence indicator may be normalized to represent a percentage. Other examples of dedicated algorithms may also be used, as a person skilled in the art would recognize.

In another particular aspect, the processing unit 610 of the server 600 determines if a received evidence is compliant with an ethic code, and further processes the received evidence only if it is compliant with the ethic code. Otherwise, the evidence is dropped. The determination of the compliance with the ethic code may be partially or entirely performed in an automatic way, using dedicated algorithms capable or parsing and analyzing the content of the evidence (e.g. the text and the hyperlinks). The determination may also be partially or entirely performed by a moderator or skilled person, capable of analyzing the evidence to determine its compliance with the ethic code.

As previously mentioned, the processing unit 610 of the server 600 may generate a demonstration for the statement. The demonstration may be generated when the processing unit 610 determines that the statement is true. The determination that the statement is true may be based on the value of the corresponding confidence indicator. For example, if the confidence indicator is higher that a pre-defined threshold, the statement is determined to be true. The determination that the statement is true may take into consideration other criteria, such as for example a minimum number of evidences received for the statement, a minimum number of evidences for the statement having a reliability value higher than a pre-defined threshold, etc. The demonstration may be generated automatically by the processing unit 610, for example by selecting as demonstration the evidence with the highest reliability value. Alternatively, the demonstration may be generated manually by a moderator or a skilled person, using the evidences with the highest reliability values as sources for writing a convincing demonstration. Furthermore, the demonstration of the statement may be transmitted to the computing devices (e.g. 201, 202, 203), as illustrated previously in relation to FIGS. 3A and 3D.

As previously mentioned, the processing unit 610 of the server 600 may determine a popularity indicator of the statement (based on one or a plurality of predefined criteria). The factual record 630 may be updated with the determined popularity indicator. Furthermore, the popularity indicator of the statement may be transmitted to the computing devices (e.g. 201, 202, 203), as illustrated previously in relation to FIGS. 3A-E.

In still another particular aspect, the communication interface 640 of the server 600 receives a plurality of statements. The processing unit 610 of the server 600 creates a specific factual record 630 for each specific statement among the plurality of received statements, and stores the plurality of factual records 630 in the memory 620. The processing unit 610 is capable of applying the aforementioned treatments and algorithms to each specific statement, independently of the other statements. Each specific factual record 630 has a specific statement with its own confidence indicator, and one or more evidences related to the specific statement with corresponding reliability values, as illustrated in FIG. 1.

In yet another particular aspect, the processing unit 610 of the server 600 determines a specific fee to be charged for each specific statement, based on a number of interactions related to the specific statement performed by the processing unit 610. The interactions may include one or several of the following: transmission of a statement to a computing device, reception of an evidence of a validity indicator from a computing device, calculation of a reliability value or a confidence indicator, etc.

As previously mentioned, the communication interface 640 of the server 600 may receive at least one validity indicator for a statement. For example, as illustrated in FIGS. 3A-D, a user of a computing device (e.g. 203 or 204) may vote on the statement, and generate a corresponding validity indicator for the statement, which is transmitted to the server 600. The processing unit 610 of the server 600 may update the factual record 630 corresponding to the statement with the at least one received validity indicator for the statement. The processing unit 610 may further assess a reliability value of the statement using the at least one corresponding validity indicator. The assessment of the reliability value of the statement may be similar to an assessment of a reliability value of an evidence. The processing unit 610 may determine the confidence indicator for the statement based on a combination of: the evidence(s) and the corresponding reliability value(s) of the evidence(s), and the reliability value of the statement.

In another particular aspect, the statement may consist of an answer to a question. The question may be related to any subject of interest, and may consist of a text stating the question, a context (a text) providing additional information with respect to the question, and at least one hyperlink related to the context (to provide sources in the form of web pages for supporting the additional information included in the context).

The question may be entered via a user interface of a first computing device (not represented in the Figures) and transmitted to the server 600. The question may be transmitted by the server 600 to a second computing device (e.g. 201) and displayed on a display of the second computing device. A statement answering the question may be entered via a user interface of the second computing device and transmitted to the server 600. From this point, the statement answering the question is treated as previously described by the server 600 and the computing devices (e.g. 201, 202, 203 and 204) interacting with the server 600. Several statements answering the question may be generated by various computing devices, and transmitted to the server 600. A specific factual record 630 is created for each specific statement received by the server 600 and answering the question, as previously described.

In still another particular aspect, the server 600 memorizes the history of each factual record, including information which were accurate at a certain time in the existence of the factual record, but which are currently no longer accurate. For instance, the history may include previous versions of the demonstration of the statement of a factual record, the demonstration having evolved in time based on the submission of new evidences. The history may also include evidences that have been rejected because they were not compliant with a rule of the ethic code. However, specific rules of the ethic code (e.g. no racist, pornographic, defamatory, etc., content is allowed) may trigger the final rejection of an evidence, without memorizing it in the history of the related facto code. The GUI 300 illustrated in FIGS. 3A-D may include a graphical element (e.g. a button, an icon, etc.) for triggering the display of the history of the factual record.

In yet another particular aspect, the GUI 300 illustrated in FIG. 3B may include a graphical element (e.g. a button, an icon, etc.) for automatically memorizing the content of a hyperlink submitted with a new evidence 22. Thus, if the owner of the web site related to the hyperlink removes the content of the hyperlink, the memorized copy is still available to support the new evidence 22. For instance, a screenshot of the content of the hyperlink may be taken and memorized with the new evidence 22. Furthermore, once the new evidence 22 has been submitted to the server 600, validated by the server 600 (compliance with the ethic code) and added by the server 600 to the corresponding factual record, the screenshot may be displayed with the hyperlink of the validated evidence 20 in the GUI 300 illustrated in FIG. 3C.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A system for collectively gathering reliable facts, the system comprising:
a memory;
a communication interface for:
receiving a statement;
receiving an evidence related to the statement; and
receiving at least one validity indicator for the evidence;
a processing unit for:
creating a factual record for the statement and storing the factual record in the memory, the factual record comprising the statement, the evidence and the at least one validity indicator for the evidence;
assessing a reliability value of the evidence using the at least one corresponding validity indicator;
determining a confidence indicator for the statement based on the evidence and the corresponding reliability value; and
updating the factual record with the reliability value of the evidence and the confidence indicator of the statement.

2. The system of claim 1, wherein the statement consists of a marketing text related to one of a product or a service.

3. The system of claim 1, wherein the evidence comprises a text and at least one hyperlink related to the text.

4. The system of claim 1, wherein:
the communication interface:
receives a plurality of evidences related to the statement;
the processing unit:
assesses a specific reliability value for each specific evidence among the plurality of received evidences; and
determines the confidence indicator for the statement based on the plurality of evidences and the corresponding plurality of reliability values.

5. The system of claim 1, wherein the processing unit determines if the received evidence is compliant with an ethic code, and further processes the evidence only if the evidence is compliant with the ethic code.

6. The system of claim 1, wherein the communication interface transmits the factual record to a computing device.

7. The system of claim 1, wherein:
the communication interface:
receives a plurality of statements;
the processing unit:
creates a specific factual record for each specific statement among the plurality of received statements.

8. The system of claim 7, wherein the processing unit determines a specific fee to be charged for each specific statement based on a number of interactions related to the specific statement performed by the processing unit.

9. The system of claim 1, wherein:
the communication interface:
receives at least one validity indicator for the statement;
the processing unit:
updates the factual record with the at least one validity indicator for the statement;
assess a reliability value of the statement using the at least one corresponding validity indicator; and
determines the confidence indicator for the statement based on a combination of: the evidence and the corresponding reliability value of the evidence, and the reliability value of the statement.

10. The system of claim 1, wherein the communication interface receives a question and the statement consists of an answer to the question.

11. A computer program product deliverable via an electronically-readable media such as storage media and communication links, the computer program product comprising instructions which when executed by a processor of a computing device provide for collectively validating facts by:
receiving from a server a factual record, the factual record including a statement and an evidence related to the statement;
displaying the statement and the evidence on a display of the computing device;
receiving via a user interface of the computing device one of the following: a validity indicator for the evidence or a new evidence related to the statement; and
transmitting to the server one of the following: the validity indicator for the evidence or the new evidence related to the statement.

12. The computer program product of claim 11, wherein the statement consists of a marketing text related to one of a product or a service.

13. The computer program product of claim 11, wherein the evidence comprises a text and at least one hyperlink related to the text.

14. The computer program product of claim 11, wherein:
the factual record further includes at least one of the following: a confidence indicator of the statement and a reliability value of the evidence; and
the at least one of the confidence indicator of the statement and the reliability value of the evidence is displayed on the display of the computing device.

15. The computer program product of claim 11, wherein:
the factual record includes a plurality of evidences related to the statement;
the plurality of evidences are displayed on the display of the computing device; and
a validity indicator for one of the plurality of evidences is received via the user interface of the computing device and transmitted to the server.

16. The computer program product of claim 11, wherein the instructions when executed by the processor further provide for collectively validating facts by:
receiving from a server a factual record, the factual record including a statement and no evidence;
displaying the statement on the display of the computing device; and
receiving via the user interface of the computing device an evidence related to the statement, and transmitting the evidence to the server.

17. The computer program product of claim 11, wherein the instructions when executed by the processor further provide for collectively validating facts by:
receiving via the user interface of the computing device a new statement, and transmitting the new statement to the server.

18. The computer program product of claim 11, wherein the instructions when executed by the processor further provide for collectively validating facts by:
receiving via the user interface of the computing device a validity indicator for the statement, and transmitting the validity indicator for the statement to the server.

19. The computer program product of claim 11, wherein the statement consists of an answer to a question and the question is displayed on the display of the computing device.

20. The computer program product of claim 19, wherein the question comprises a text, a context related to the question, and at least one hyperlink related to the context.
